(19) United States
(12) Patent Application Publication
(10) Pub. No.: US 2013/0300389 A1
(43) Pub. Date: Nov. 14, 2013

(54) REGULATOR CIRCUIT

(71) Applicant: Hyun Chul LEE, Seoul (KR)

(72) Inventor: Hyun Chul LEE, Seoul (KR)

(73) Assignee: SK HYNIX INC., Icheon-si (KR)

(21) Appl. No.: 13/601,951

(22) Filed: Aug. 31, 2012

(30) Foreign Application Priority Data
May 8, 2012 (KR) 10-2012-0048677

(51) Int. Cl. G05F 1/10

(52) U.S. Cl. 323/282

(57) ABSTRACT

A regulator circuit includes a comparator configured to compare a feedback voltage obtained by dividing an output voltage with a reference voltage to output a comparison signal; a controller configured to control an electric potential of an internal node according to the comparison signal; a current supply unit configured to increase an electric potential of an output node by applying a pump voltage received from a pump circuit according to the electric potential of the internal node; and a discharge unit configured to reduce the potential of the output voltage by discharging the electric potential of the output node according to the electric potential of the internal node.

### CROSS-REFERENCE TO RELATED APPLICATION

This application claims priority to and the benefit of Korean Patent Application No. 10-2012-0048677, filed May 8, 2012, the disclosure of which is incorporated herein by reference in its entirety.

### BACKGROUND

1. Technical Field

The present invention generally relates to a regulator circuit. Additionally, the present invention generally relates to a regulator circuit capable of rapidly discharging an output voltage when the output voltage is higher than a desired voltage.

2. Related Art

In general, circuits that need voltages that are greater than a power supply voltage are included in memories, integrated circuit (IC) chips, and the like. In most cases, high-voltage generators that apply voltages greater than the power supply voltage generate such voltages by using a charge pump. The charge pump is driven in response to a clock signal generated using an oscillator.

A regulator circuit is needed to maintain an output voltage of the charge pump at a constant level. According to one general regulation method, the output voltage of the charge pump is compared with a reference voltage, current supplied from the charge pump is continuously supplied to an output terminal so as to increase an electric potential of the output terminal when the output voltage is lower than the reference voltage, and the current supplied from the charge pump is blocked so as to prevent the electric potential of the output terminal from increasing when the output voltage is higher than the reference voltage.

In the regulator circuit, when a high load is applied to the output terminal and the output voltage is thus increased, current should be rapidly discharged via a discharge path but actually cannot be rapidly discharged since an amount of current flowing through the discharge path is limited.

### SUMMARY OF THE INVENTION

The present invention is generally directed to a regulator circuit in which a discharge unit is disposed at an output terminal to stabilize an output voltage by rapidly discharging the output voltage when an electric potential of the output terminal is higher than a desired voltage.

An embodiment provides a regulator circuit including a regulator configured to generate an output voltage having a constant potential by regulating a pump voltage output from a pump circuit; and a discharge unit configured to reduce a potential of the output voltage when the output voltage is higher than a desired voltage.

An embodiment provides a regulator circuit including a comparator configured to compare a feedback voltage obtained by dividing an output voltage with a reference voltage to output a comparison signal; a controller configured to control an electric potential of an internal node in response to the comparison signal; a current supply unit configured to increase an electric potential of an output node by applying a pump voltage output from a pump circuit to the output node in response to the electric potential of the internal node; and a discharge unit configured to reduce the potential of the output voltage by discharging the electric potential of the output node in response to the electric potential of the internal node.

An embodiment provides a regulator circuit including a comparator configured to compare a feedback voltage obtained by dividing an output voltage with a reference voltage to output a comparison signal; a controller configured to control an electric potential of an internal node in response to the comparison signal; a current supply unit configured to increase an electric potential of an output node by applying a pump voltage received from a pump circuit to the output node in response to the electric potential the internal node; and a discharge unit configured to reduce the potential of the output voltage by discharging the electric potential of the output node in response to the electric potential of the internal node, wherein the discharge unit is configured to discharge the electric potential of the output node when the output voltage is higher than a desired voltage, and the discharge unit is deactivated when the output voltage is lower than the desired voltage.

### BRIEF DESCRIPTION OF THE DRAWING

The above and other features and advantages of the present invention will become more apparent to those of ordinary skill in the art by describing in detail embodiments thereof with reference to the attached drawing in which:

FIG. 1 is a detailed circuit diagram of a regulator circuit according to an embodiment.

### DETAILED DESCRIPTION

Various embodiments will be described hereinafter with reference to the accompanying drawing, in which embodiments of the invention are illustrated. These embodiments may, however, be embodied in different forms and should not be construed as limited to the embodiments set forth herein. Rather, these embodiments are provided so that this disclosure will be thorough and complete and will fully convey the concept of the invention to those of ordinary skill in the art. The scope of the invention is defined in the claims and their equivalents.

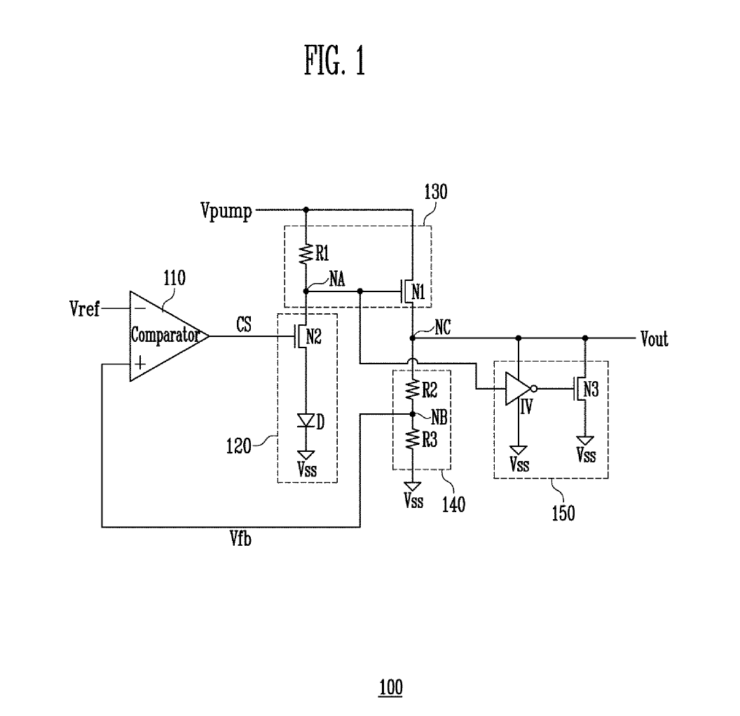

FIG. 1 is a detailed circuit diagram of a regulator circuit 100 according to an embodiment.

Referring to FIG. 1, the regulator circuit 100 may include a comparator 110, a controller 120, a current supply unit 130, a voltage division unit 140, and a discharge unit 150.

The comparator 110 may compare a reference voltage Vref with a feedback voltage Vfb obtained by dividing an output voltage Vout, and may output a comparison signal cs. For example, the comparator 110 may output a comparison signal cs that has a logic low voltage level when the reference voltage Vref is higher than the feedback voltage Vfb, and may output a comparison signal cs that has a logic high voltage level when the reference voltage Vref is lower than the feedback voltage Vfb.

The controller 120 may include an NMOS transistor N2 and a diode D. The NMOS transistor N2 and the diode D may be connected in series between a node NA or internal node and a ground voltage Vss source. The NMOS transistor N2 may control an electric potential of the node NA by forming a current path through the diode D, in response to the comparison signal cs.

The current supply unit 130 may include a resistor R1 and an NMOS transistor N1. The resistor R1 may be connected between a pump voltage Vpump source (i.e., a pump circuit supplying a Vpump) and the node NA to supply current to the node NA. The NMOS transistor N1 may be connected between the pump voltage Vpump source and an output node NC. The NMOS transistor N1 may control an amount of current to be supplied to the output node NC, in response to the electric potential of the node NA.

The voltage division unit 140 may include resistors R2 and R3. The resistors R2 and R3 may be connected in series between the output node NC and the ground voltage Vss source. The resistors R2 and R3 may generate the feedback voltage Vfb, which may be output through the node NB, by dividing an electric potential of the output node NC in response to resistance values thereof.

The discharge unit 150 may include an inverter IV and an NMOS transistor N3. The inverter IV may invert and output the electric potential of the node NA of the current supply unit 130. The NMOS transistor N3 may be connected between the output node NC and the ground voltage Vss source, and may discharge the electric potential of the output node NC in response to an output signal of the inverter IV.

Operations of the regulator circuit 100 according to an embodiment will now be described with reference to

FIG. 1.

1) When the output voltage Vout is lower than a desired voltage

In this example, the feedback voltage Vfb obtained by dividing the output voltage Vout is lower than the reference voltage Vref. Thus, the comparator 110 may output the comparison signal cs that has the logic low voltage level.

The controller 120 may block the current path in response to the comparison signal cs that has the logic low voltage level. In other words, the NMOS transistor N2 may be turned off in response to the comparison signal cs having the logic low voltage level, and thus, the current path of current flowing through the controller 120 may be blocked.

When the current path of the current flowing through the controller 120 is blocked, the electric potential of the node NA of the current supply unit 130 may increase. Thus, an amount of current to be supplied to the output node NC via the NMOS transistor N1 may increase. Accordingly, the electric potential of the output node NC may increase. In this example, the discharge unit 150 may be deactivated in response to the electric potential of the node NA.

2) When the output voltage Vout is higher than the desired voltage

In this example, the feedback voltage Vfb obtained by dividing the output voltage Vout is higher than the reference voltage Vref. Thus, the comparator 110 may output the comparison signal cs that has the logic high voltage level.

The controller 120 may form the current path in response to the comparison signal cs having the logic high voltage level. In other words, the NMOS transistor N2 may be turned on in response to the comparison signal cs having the logic high voltage level, and thus, the current path of current flowing through the controller 120 may be formed.

When the current path of the current flowing through the controller 120 is formed, the electric potential of the node NA of the current supply unit 130 may go low.

Thus, an amount of current to be supplied to the output node NC via the NMOS transistor N1 may decrease. Also, the discharge unit 150 may be activated in response to the electric potential of the node NA, thus decreasing the electric potential of the output node NC.

As described above, according to the above embodiments, when the electric potential of the output node is higher than a desired voltage, the electric potential of the output node can be rapidly lowered via the discharge unit.

According to the above embodiments, the discharge unit may be disposed at the output terminal so that the electric potential of the output terminal can be rapidly discharged when the electric potential of the output terminal is higher than the desired voltage.

In the drawings and specification, there are disclosed embodiments of the invention and, although specific terms are employed, they are used in a generic and descriptive sense only and not for purposes of limitation. Therefore, it will be understood by those of ordinary skill in the art that various changes in form and details may be made therein without departing from the spirit and scope of the various embodiments.

What is claimed is:

1. A regulator circuit comprising:
a regulator configured to generate an output voltage having a constant potential by regulating a pump voltage output from a pump circuit; and
a discharge unit configured to reduce a potential of the output voltage when the output voltage is higher than a desired voltage.

2. The regulator circuit of claim 1, wherein the regulator comprises:
a comparator configured to compare a feedback voltage obtained by dividing the output voltage with a reference voltage to output a comparison signal;
a controller configured to control an electric potential of an internal node in response to the comparison signal; and
a current supply unit configured to apply the pump voltage to an output node in response to the electric potential of the internal node.

3. The regulator circuit of claim 2, wherein the discharge unit is configured to reduce the potential of the output voltage by discharging an electric potential of the output node in response to the electric potential of the internal node.

4. The regulator circuit of claim 1, wherein the discharge unit is configured to discharge an electric potential of an output node when the regulator reduces an amount of current of the pump voltage to be applied to the output node.

5. The regulator circuit of claim 2, wherein the discharge unit comprises:
an inverter configured to output a control signal in response to the electric potential of the internal node; and
a transistor configured to connect the output node and a ground voltage source in response to the control signal received from the inverter.

6. The regulator circuit of claim 2, wherein the controller is configured to maintain or discharge the electric potential of the internal node in response to the comparison signal.

7. The regulator circuit of claim 2, wherein the current supply unit is configured to apply the pump voltage to the output node while controlling an amount of current of the pump voltage to be applied to the output node in response to the electric potential of the internal node.

8. The regulator circuit of claim 2, wherein the regulator comprises:
a voltage division unit including a first resistor and a second resistor connected in series between the output node and a ground voltage source,
wherein the first and second resistors generate the feedback voltage compared by the comparator.

9. A regulator circuit comprising:
a comparator configured to compare a feedback voltage obtained by dividing an output voltage with a reference voltage to output a comparison signal;
a controller configured to control an electric potential of an internal node in response to the comparison signal;
a current supply unit configured to increase an electric potential of an output node by applying a pump voltage output from a pump circuit to the output node in response to the electric potential of the internal node; and
a discharge unit configured to reduce the potential of the output voltage by discharging the electric potential of the output node in response to the electric potential of the internal node.

10. The regulator circuit of claim 9, wherein the discharge unit is configured to discharge the electric potential of the output node when the current supply unit reduces an amount of current of the pump voltage to be applied to the output node.

11. The regulator circuit of claim 10, wherein the discharge unit comprises:
an inverter configured to output a control signal in response to the electric potential of the internal node; and
a transistor configured to connect the output node and a ground voltage source in response to the control signal received from the inverter.

12. The regulator circuit of claim 9, wherein the controller is configured to maintain or discharge the electric potential of the internal node in response to the comparison signal.

13. The regulator circuit of claim 9, wherein the current supply unit is configured to apply the pump voltage to the output node while controlling an amount of current of the pump voltage to be applied to the output node in response to the electric potential of the internal node.

14. The regulator circuit of claim 9, further comprising:
a voltage division unit including a first resistor and a second resistor connected in series between the output node and a ground voltage source,
wherein the first and second resistors generate the feedback voltage which is outputted, through a node located between the first resistor and second resistor, to the comparator.

15. A regulator circuit comprising:
a comparator configured to compare a feedback voltage obtained by dividing an output voltage with a reference voltage to output a comparison signal;
a controller configured to control an electric potential of an internal node in response to the comparison signal;
a current supply unit configured to increase an electric potential of an output node by applying a pump voltage received from a pump circuit to the output node in response to the electric potential the internal node; and
a discharge unit configured to reduce the potential of the output voltage by discharging the electric potential of the output node in response to the electric potential of the internal node,
wherein the discharge unit is configured to discharge the electric potential of the output node when the output voltage is higher than a desired voltage, and the discharge unit is deactivated when the output voltage is lower than the desired voltage.

16. The regulator circuit of claim 15, wherein the discharge unit is configured to discharge the electric potential of the output node when the current supply unit reduces an amount of current of the pump voltage to be applied to the output node.

17. The regulator circuit of claim 15, wherein the discharge unit comprises:
an inverter configured to output a control signal in response to the electric potential of the internal node; and
a transistor configured to connect the output node and a ground voltage source in response to the control signal received from the inverter.

18. The regulator circuit of claim 15, wherein the controller is configured to maintain or discharge the electric potential of the internal node in response to the comparison signal.

19. The regulator circuit of claim 15, wherein the current supply unit is configured to apply the pump voltage to the output node while controlling an amount of current of the pump voltage to be applied to the output node in response to the electric potential of the internal node.

20. The regulator circuit of claim 15, wherein the regulator comprises:
a voltage division unit including a first resistor and a second resistor connected in series between the output node and a ground voltage source,
wherein the first and second resistors generate the feedback voltage compared by the comparator.
